(19) United States
(12) Patent Application Publication
(10) Pub. No.: US 2023/0182425 A1
(43) Pub. Date: Jun. 15, 2023

(54) TIRE MANUFACTURING APPARATUS

(71) Applicant: Sumitomo Rubber Industries, Ltd., Kobe-shi (JP)

(72) Inventor: Shuji KAGIMOTO, Kobe-shi (JP)

(73) Assignee: Sumitomo Rubber Industries, Ltd., Kobe-shi (JP)

(21) Appl. No.: 17/993,316

(22) Filed: Nov. 23, 2022

(30) Foreign Application Priority Data
Dec. 10, 2021 (JP) 2021-201055

(51) Int. Cl. B29D 30/32

(52) U.S. Cl. CPC B29D 30/32; B29D 2030/3214

(57) ABSTRACT

An apparatus for manufacturing a pneumatic tire, comprises: a cylindrical former for forming a tire base from rubber members, a carcass and bead cores; and bead lock devices arranged at both ends of the former in its axial direction. Each bead lock device is expandable and contractable in diameter, and comprises a holding portion for supporting the bead core from the inside in the radial direction when expanded. The holding portion comprises an axially inner flange, an axially outer flange, and a bottom surface connecting therebetween. The height of the axially inner flange is greater than the height of the outer flange by 5 mm or more.

### BACKGROUND OF THE INVENTION

### Field of the Invention

The present disclosure relates to an apparatus for manufacturing a pneumatic tire.

### Background Art

Patent document 1 below discloses an apparatus for manufacturing a green tire in which both edge portions of a cylindrical tire casing are folded back around annular bead cores under such a condition that portions of the tire casing corresponding to the tire bead portions are each locked between the bead core and a bead holding device.
Patent Document 1: Japanese Unexamined Patent Publication No. 2019-048386

### SUMMARY OF THE INVENTION

### Problems to be Solved by the Invention

In the green tire manufacturing apparatus according to Patent Document 1, when the position of an axially inner end of a chafer rubber spliced in advance with a sidewall rubber is displaced axially outward due to a manufacturing error or the like, and an axially outer portion of the tire casing is folded under the bead locked state, then the axially inner edge of the chafer rubber is not sufficiently turned up around the bead core in the finished tire, and there is a possibility that the adhesion between the axially inner edge and an inner liner rubber becomes insufficient.

The present disclosure was made in view of the circumstances as described above, and a main objective of the present disclosure is to provide a tire manufacturing apparatus in which a rubber member such as chafer rubber can be sufficiently turned up to provide a good adhesion.

### Means for Solving the Problems

According to the present disclosure, a tire manufacturing apparatus for manufacturing a pneumatic tire, comprises:

a cylindrical former for forming a tire base from rubber members, a carcass and a pair of bead cores; and

a pair of bead lock devices arranged at both ends of the former in its axial direction,

wherein

each of the bead lock devices is expandable and contractable, and has a holding portion for supporting the bead core from the inside in the radial direction when expanded,

wherein

the holding portion comprises a radially-supporting surface for the bead core, an axially inner flange located axially inside the radially-supporting surface, an axially outer flange located axially outside the radially-supporting surface, and a bottom connecting between the inner flange and the outer flange, and

a radial height of the axially inner flange from the bottom is greater than a radial height of the axially outer flange from the bottom, and the difference therebetween is 5 mm or more.

### Effects of the Invention

Therefore, in the tire manufacturing apparatus according to the present disclosure, since the axially inner flange of the holding portion is higher than the axially outer flange, the axially inner flange can first turn up the axially inner edge of the rubber member such as chafer rubber, around the bead core. As a result, even if there is some displacement in the rubber member, it can be reliably turned up, and sufficient adhesion can be secured to suppress a separation failure.

### BRIEF DESCRIPTION OF THE DRAWINGS

FIG. 1 is a cross-sectional view showing an example of a pneumatic tire manufactured by a tire manufacturing apparatus as an embodiment of the present disclosure.

FIG. 2 is a schematic diagram showing a tire manufacturing apparatus as an embodiment of the present disclosure.

FIG. 3 is a schematic diagram showing a diameter-expanded state of the bead lock device of the tire manufacturing apparatus.

FIG. 4 is an enlarged schematic diagram showing the bead lock device.

FIG. 5 is an enlarged schematic diagram showing another example of the bead lock device.

### DETAILED DESCRIPTION OF THE INVENTION

An embodiment of the present disclosure will now be described in detail in conjunction with accompanying drawings.

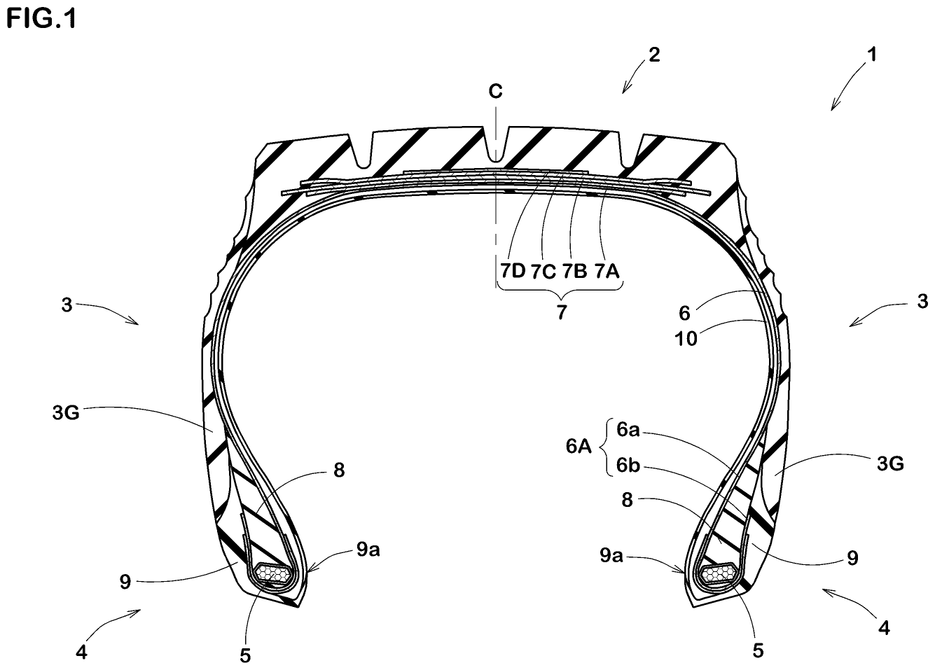

FIG. 1 is a tire meridian cross-sectional view of a pneumatic tire 1 manufactured by a tire manufacturing apparatus 11 as an embodiment of the present disclosure.

The pneumatic tire 1 shown in FIG. 1 is designed so as to be suitably used as a heavy-duty tire, for example. The pneumatic tire 1 manufactured by the tire manufacturing apparatus 11 is not limited to tires in such a category, and may be a passenger car tire, a motorcycle tire and the like, for example.

The pneumatic tire 1 comprises an annular tread portion 2, a pair of sidewall portions 3 on both sides in the tire axial direction of the tread portion 2, and a bead portion 4 inside each of the sidewall portions 3 in the tire radial direction.

The bead portion 4 is provided with a bead core 5 extending annularly. For example, the bead core 5 is made of steel wire.

The pneumatic tire 1 comprises, for example, a carcass 6 extending between the bead cores 5 of the bead portions 4 through the tread portion 2 and sidewall portions 3, and a belt layer 7 disposed radially outside of the carcass 6 in the tread portion 2.

The carcass 6 has at least one, in the present embodiment, only one carcass ply 6A.

The carcass ply 6A preferably comprises a main portion 6a and turnup portions 6b.

The main portion 6a is, for example, a portion extending between the bead cores 5 of the bead portions 4 through the tread portion 2 and the sidewall portions 3.
It is desirable that the turnup portions 6b extend from the main portion 6a and are turned up around the bead cores 5 from the axially inside to the axially outside in the tire axial direction.
For example, the turnup portion 6b may employ a so-called ultra-high turn-up structure in which the outer ends in the tire radial direction are located between the main portion 6a and the belt layer 7.

The belt layer 7 is composed of at least one belt ply, in the present embodiment, four belt plies 7A, 7B, 7C and 7D which are arranged in this order from the inside to the outside of the tire in the tire radial direction. Preferably, each belt ply 7A-7D is composed of steel cords.

Each of the sidewall portions 3 is preferably provided with a sidewall rubber 3G which defines the axially outer surface of the sidewall portion 3.

The sidewall rubber 3G is, for example, disposed on the outer side in the tire axial direction of the main portion 6a of the carcass ply 6A.
The sidewall rubber 3G is preferably made of a rubber compound.

Each of the bead portions 4 in this example is provided with a bead apex rubber 8 extending radially outside from the bead core 5 in a tapered manner, and a chafer rubber 9 which defines the axially outer surface of the bead portion 4.

The bead apex rubber 8 has, for example, a substantially triangular cross-sectional shape extending radially outwardly from the bead core 5, located between the main portion 6a and the turnup portion 6b of the carcass ply 6A.

The bead apex rubber 8 is preferably made of a rubber compound.

The chafer rubber 9 extends from the axially outer side of the turnup portion 6b to the axially inner side of the bead core 5. In the present embodiment, the axially inner end 9a the chafer rubber 9 is positioned axially inside the bead core 5.

The chafer rubber 9 is preferably made of a hard rubber compound.
Such chafer rubber 9 tends to be easily separated from the adjacent rubber member, staring from the inner end 9a, during manufacturing of the tire base, because the amount of turnup of the chafer rubber 9 from the axially outside to the inside, is small.

The pneumatic tire 1 preferably comprises an inner liner 10 disposed on the tire inner cavity side of the main portion 6a of the carcass ply 6A.

The inner liner 10 is made of a gas-impermeable rubber compound.
The inner liner 10 in this example has a radially inner end located between the bead core 5 and the chafer rubber 9.

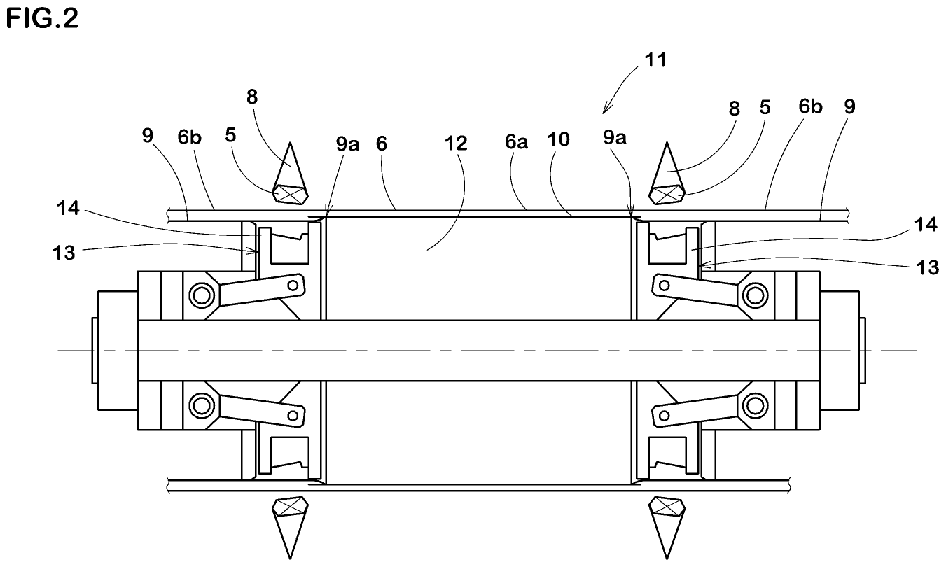

FIG. 2 is a schematic diagram showing the tire manufacturing apparatus 11 in the present embodiment. The tire manufacturing apparatus 11 is for manufacturing a tire base body of the pneumatic tire 1.

The tire manufacturing apparatus 11 comprises a cylindrical former 12, and a pair of bead lock device 13 disposed on both end sides of the former 12 in its axial direction.

The former 12 is for building the tire base by applying the carcass 6, rubber members G and the bead cores 5 thereon.

For example, the rubber members G include the sidewall rubber 3G the chafer rubber 9, the bead apex rubber 8, the inner liner 10 and the like.
In the present embodiment, the sidewall rubber 3G and the chafer rubber 9 are spliced with each other in advance.

Further, it is preferable that the bead apex rubber 8 and the bead core 5 are assembled in advance.

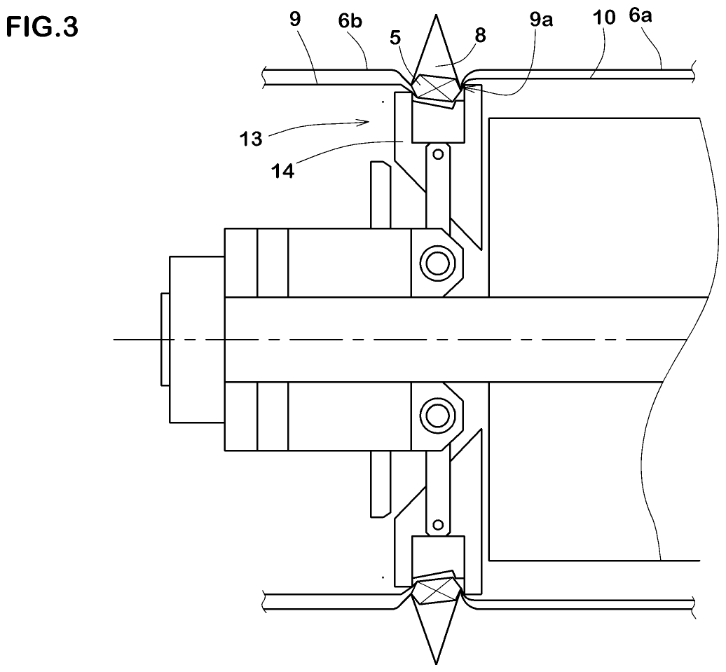

FIG. 3 is a schematic diagram showing a bead lock device 13 in its diameter-expanded state. Each bead lock device 13 can be expanded and contracted in diameter as shown in FIGS. 2 and 3.

Preferably, the bead lock device 13 comprises a holding portion 14 which supports the bead core 5 from the inside in the radial direction when expanded.
Such bead lock device 13 can prevent the position of the bead core 5 from being displaced when the rubber members G are folded around the bead core 5 by a shaping bladder (not shown) or the like.

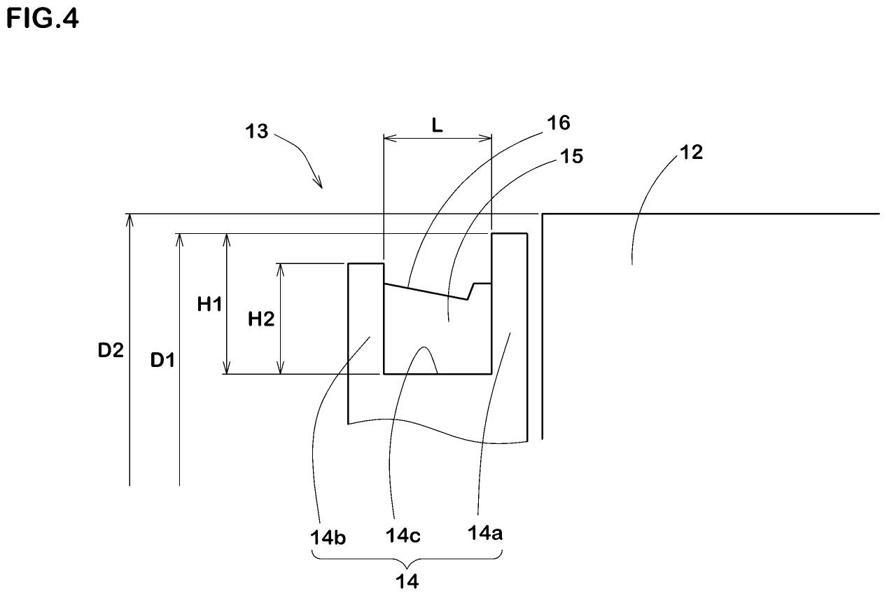

FIG. 4 is an enlarged schematic diagram showing the bead lock device 13. As shown in FIG. 4, in the bead lock device 13 in the present embodiment, the holding portion 14 is provided with a radially-supporting surface 16 for the bead core, and a pair of flanges: an inner flange 14a and an outer flange 14b located axially inside and axially outside, respectively, of the radially-supporting surface 16.

Preferably, the holding portion 14 comprises a bottom 14c connecting between the inner flange 14a and the outer flange 14b.

In the present embodiment, the height H1 of the inner flange 14a from the bottom 14c is greater than the height H2 of the outer flange 14b from the bottom 14c, and the difference H1-H2 is 5 mm or more.

Such bead lock device 13 can reliably turn up the end portion 9a of the chafer rubber 9 even if the position of the end portion 9a of the chafer rubber 9 is displaced due to a manufacturing error or the like. Therefore, the tire manufacturing apparatus 11 of the present embodiment can prevent the separation of the rubber member G such as the chafer rubber 9.

Preferably, the holding portion 14 comprises a bead lock band 15 which supports the bead core 5. That is, the bead lock band 15 provides the above-mentioned radially-supporting surface 16 which supports the radially inner surface of the annular bead core. The bead lock band 15 in this example is made of an elastic material.

Such bead lock device 13 can firmly support the bead core 5 with elasticity.
Further, by replacing the bead lock band 15 with that having a different size or shape, the holding portion 14 can support different types of bead cores 5.

The height H1 of the inner flange 14a from the bottom 14c is preferably 45 mm to 50 mm. The height H2 of the outer flange 14b from the bottom 14c is preferably 35 mm to 40 mm. Such bead lock device 13 can secure a sufficient thickness (dimension in the radial direction) of the bead lock band 15, and can strongly support the bead core 5 by a large elastic force of the bead lock band 15.

The axial distance L between the inner flange 14a and the outer flange 14b is preferably 30 mm to 50 mm. Such bead lock device 13 can reliably support the bead core 5 even when the position of the bead core 5 is displaced.

In the diameter-reduced state of the bead lock device 13, as shown in FIG. 2 and FIG. 4, the outer diameter D1 of the inner flange 14a is preferably set to be equal to or smaller than the outer diameter D2 of the former 12.

Thereby, when the rubber members G and the like are applied to or detached from the former 12, the rubber members G and the like can be prevented from contacting with the bead lock device 13, and the damage due to such contact can be prevented.

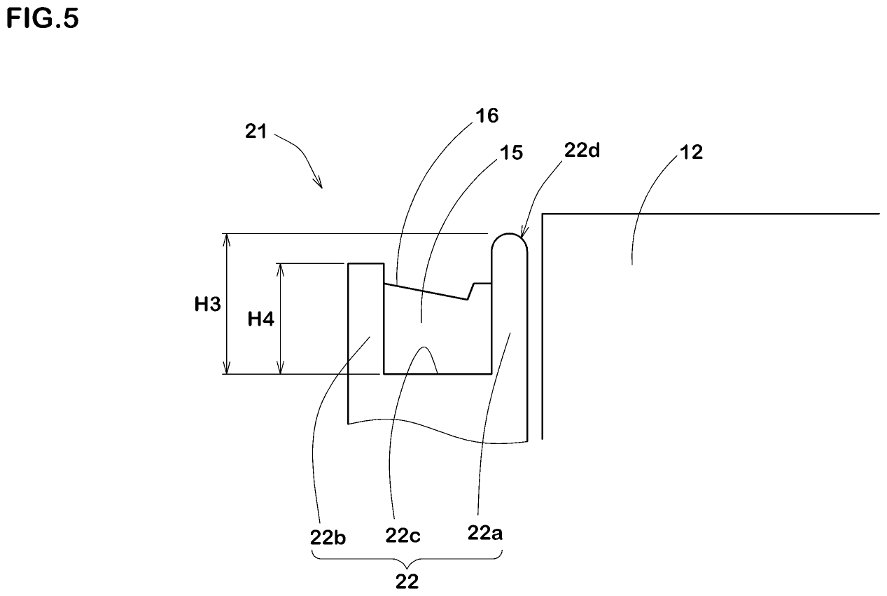

FIG. 5 is an enlarged schematic diagram showing a bead lock device 21 as another example. Components having the same functions as those of the above-described embodiment are given the same reference numerals, and redundant descriptions thereof are omitted.

As shown in FIG. 5, the bead lock device 21 comprises a holding portion 22 which supports the bead core 5 from the radially inside when expanded.

The holding portion 22 in this example comprises the radially-supporting surface 16 for the bead core, and an inner flange 22a and an outer flange 22b located axially inside and axially outside, respectively, of the radially-supporting surface 16.

The holding portion 22 preferably comprises a bottom 22c connecting the inner flange 22a and the outer flange 22b.

Similarly to the former example, in this example, too, the height H3 of the inner flange 22a from the bottom 22c is greater than the height H4 of the outer flange 22b from the bottom 22c, and the difference H3-H4 is 5 mm or more.

Such bead lock device 21 can reliably turn up the end portion 9a of the chafer rubber 9 even if the position of the end portion 9a of the chafer rubber 9 is displaced due to a manufacturing error or the like.

In this example, the radially outer end 22d of the inner flange 22a is chamfered or rounded. In FIG. 5, the radially outer end 22d is rounded by a radius of not less than 2 mm. Such bead lock device 21 can suppress breakage of the rubber members a shaping bladder (not shown) and the like, even if they come into contact with the inner flange 22a.

While detailed description has been made of preferable embodiments of the present invention, the present invention can be embodied in various forms without being limited to the illustrated embodiments.

### Statement of the Present Disclosure

The present disclosure is as follows:
Disclosure 1: A tire manufacturing apparatus for manufacturing a pneumatic tire, comprising: a cylindrical former for forming a tire base from rubber members, a carcass and a pair of bead cores; and a pair of bead lock devices arranged at both ends of the former in its axial direction, wherein

each of the bead lock devices is expandable and contractable, and has a holding portion for supporting the bead core from the inside in the radial direction when expanded, wherein

the holding portion comprises a radially-supporting surface for the bead core, an axially inner flange located axially inside the radially-supporting surface, an axially outer flange located axially outside the radially-supporting surface, and a bottom connecting between the inner flange and the outer flange, and

a radial height of the axially inner flange from the bottom is greater than a radial height of the axially outer flange from the bottom, and the difference therebetween is 5 mm or more.

Disclosure 2: The tire manufacturing apparatus according to Disclosure 1, wherein the axial distance between the inner flange and the outer flange is 30 to 50 mm.
Disclosure 3: The tire manufacturing apparatus according to Disclosure 1 or 2, wherein the radially outer end of the inner flange is chamfered or rounded by a radius of not less than 2 mm.
Disclosure 4: The tire manufacturing apparatus according to Disclosure 1, 2 or 3, wherein an outer diameter of said inner flange is equal to or less than an outer diameter of said former in a diameter-reduced state.
Disclosure 5: The tire manufacturing apparatus according to Disclosure 1, 2, 3 or 4, wherein a bead lock band which supports the bead core is disposed in the holding portion.

### DESCRIPTION OF THE REFERENCE SIGNS

1 pneumatic tire
5 bead core
6 carcass
11 tire manufacturing device
12 former
13 bead lock device
14 holding portion
14a inner flange
14b outer flange
14c bottom

1. A tire manufacturing apparatus for manufacturing a pneumatic tire, comprising:
a cylindrical former for forming a tire base from rubber members, a carcass and a pair of bead cores; and
a pair of bead lock devices arranged at both ends of the former in its axial direction,
wherein
each of the bead lock devices is expandable and contractable, and has a holding portion for supporting the bead core from the inside in the radial direction when expanded, wherein
the holding portion comprises a radially-supporting surface for the bead core, an axially inner flange located axially inside the radially-supporting surface, an axially outer flange located axially outside the radially-supporting surface, and a bottom connecting between the inner flange and the outer flange, and
a radial height of the axially inner flange from the bottom is greater than a radial height of the axially outer flange from the bottom, and the difference therebetween is 5 mm or more.

2. The tire manufacturing apparatus according to claim 1, wherein
the axial distance between the inner flange and the outer flange is 30 to 50 mm.

3. The tire manufacturing apparatus according to claim 1, wherein
the radially outer end of the inner flange is chamfered or rounded by a radius of not less than 2 mm.

4. The tire manufacturing apparatus according to claim 2, wherein
the radially outer end of the inner flange is chamfered or rounded by a radius of not less than 2 mm.

5. The tire manufacturing apparatus according to claim 1, wherein
an outer diameter of said inner flange is equal to or less than an outer diameter of said former in a diameter-reduced state.

6. The tire manufacturing apparatus according to claim 2, wherein
an outer diameter of said inner flange is equal to or less than an outer diameter of said former in a diameter-reduced state.

7. The tire manufacturing apparatus according to claim 3, wherein
an outer diameter of said inner flange is equal to or less than an outer diameter of said former in a diameter-reduced state.

8. The tire manufacturing apparatus according to claim 4, wherein
an outer diameter of said inner flange is equal to or less than an outer diameter of said former in a diameter-reduced state.

9. The tire manufacturing apparatus according to claim 1, wherein
a bead lock band which supports the bead core is disposed in the holding portion.

10. The tire manufacturing apparatus according to claim 2, wherein
a bead lock band which supports the bead core is disposed in the holding portion.

11. The tire manufacturing apparatus according to claim 3, wherein
a bead lock band which supports the bead core is disposed in the holding portion.

12. The tire manufacturing apparatus according to claim 4, wherein
a bead lock band which supports the bead core is disposed in the holding portion.

13. The tire manufacturing apparatus according to claim 5, wherein
a bead lock band which supports the bead core is disposed in the holding portion.

14. The tire manufacturing apparatus according to claim 6, wherein
a bead lock band which supports the bead core is disposed in the holding portion.

15. The tire manufacturing apparatus according to claim 7, wherein
a bead lock band which supports the bead core is disposed in the holding portion.

16. The tire manufacturing apparatus according to claim 8, wherein
a bead lock band which supports the bead core is disposed in the holding portion.
